(19) United States
(12) Patent Application Publication
(10) Pub. No.: US 2018/0009486 A1
(43) Pub. Date: Jan. 11, 2018

(54) SHIELDING UNIT

(71) Applicant: Minetec S.A., Santiago (CL)

(72) Inventors: Claudio Zamorano, Santiago (CL); Bernardo Vera, Santiago (CL); Gonzalo Camilla, Santiago (CL)

(21) Appl. No.: 15/402,043

(22) Filed: Jan. 9, 2017

(30) Foreign Application Priority Data
Jul. 8, 2016 (CL) 1759-2016

(51) Int. Cl. B62D 33/04; F41H 7/04; B60P 1/64

(52) U.S. Cl. CPC B62D 33/04; B60P 1/6409; F41H 7/04

(57) ABSTRACT

Embodiments of the invention relate to a shielding unit for a hopper truck.

### CROSS-REFERENCE TO RELATED APPLICATIONS

This application claims the benefit of co-pending Chilean Industrial Design Application No. 1759-2016, filed 8 Jul. 2016, which is hereby incorporated herein as though fully set forth.

### SUMMARY

Embodiments of the invention relate to a shielding unit for a hopper truck, whose geometric characteristics are described below.

### BRIEF DESCRIPTION OF THE DRAWINGS

FIG. 1 illustrates the plan view of the shielding unit.

FIG. 2 illustrates the right view of the shielding unit.

FIG. 3 illustrates the left view of the shielding unit.

FIG. 4 illustrates the front view of the shielding unit.

FIG. 5 illustrates an isometric view of the shielding unit.

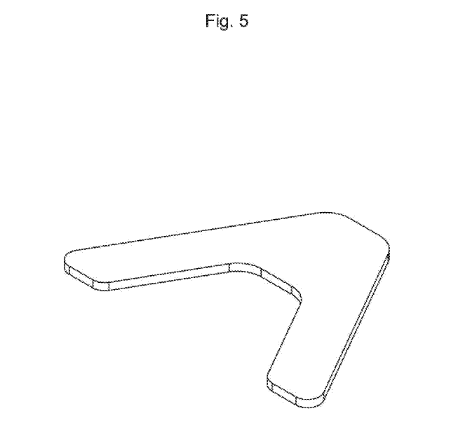

### DETAILED DESCRIPTION

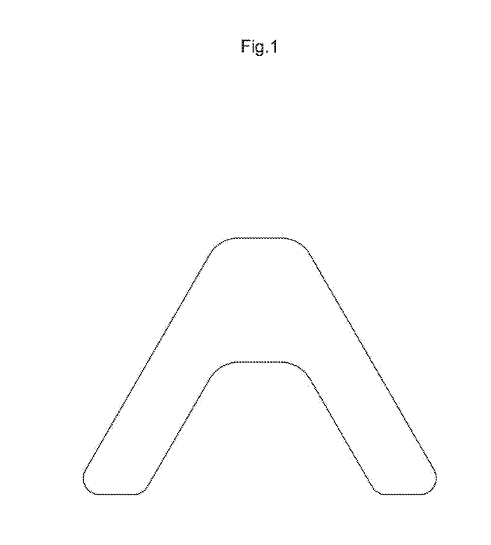

Embodiments of the invention are applicable to the design of a shielding unit for truck hopper, generated from a form of 6.2 u high by 8.6 u wide (FIG. 1), symmetric about its vertical axis, which is formed from a line of 0.52 u long that is 3.2 or a height from the base of the figure, which reaches an angle of 105° and projects 3 u up to an angle of 105° forming a horizontal line of 0.76 u forming an angle of 45° projecting in a line of 6.1 u up to an angle of 105° projecting 0.4 u up to the vertical axis.

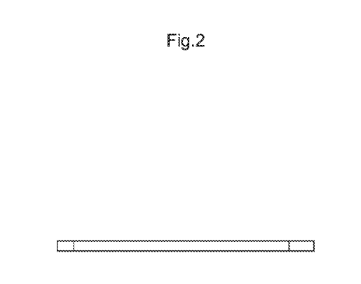

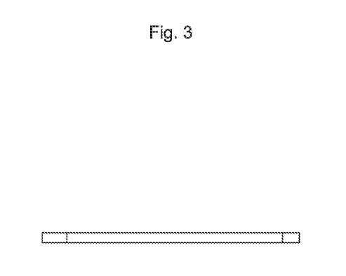

On its right view (FIG. 2) and on its left view (FIG. 3), the shielding unit is 6.2 u wide and 0.25 u high, its sides being straight and its angles 90°.

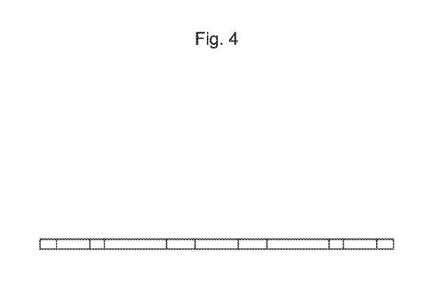

In the front view of the shielding unit (FIG. 4), it is 8.6 u wide and 0.25 u high, its sides are straight and its angles 90°.

The proportionality relationships between the parts of the shielding unit which are detailed below shall refer to the following:

A It represents the plan view, in its height.

B It represents the plan view, in its width.

C It represents the right view, in its height.

D It represents the right view, in its width.

E It represents the front view, in its width.

A:B=1:1.38

A:C=1:0.04

A:D=1:1

A:E=1:1.38

What is claimed is:

1. A shielding unit comprising:
a body;
a first leg extending from the body in a plane;
a second leg extending from the body in the same plan as the first leg,
wherein the first and second legs extend from the body symmetrically with respect to a vertical axis of the shielding unit.

2. The shielding unit of claim 1, wherein the first and second legs form an angle of approximately 45°.

3. The shielding unit of claim 1, wherein a ratio of a height of the shielding unit to a width of the shielding unit is approximately 1:1.38.
